(19) United States
(12) Patent Application Publication
(10) Pub. No.: US 2011/0141383 A1
(43) Pub. Date: Jun. 16, 2011

(54) WRITING DEVICE

(75) Inventors: Taijyu GAN, Ebina-shi (JP); Masahiro Sato, Ebina-shi (JP); Haruo Harada, Ebina-shi (JP); Takashi Morikawa, Ebina-shi (JP); Chikara Manabe, Ebina-shi (JP); Chisato Urano, Ebina-shi (JP); Atsushi Hirano, Ebina-shi (JP); Hiroshi Arisawa, Ebina-shi (JP)

(73) Assignee: FUJI XEROX CO., LTD., TOKYO (JP)

(21) Appl. No.: 12/776,843

(22) Filed: May 10, 2010

(30) Foreign Application Priority Data
Dec. 16, 2009 (JP) 2009-285050

(51) Int. Cl. G02F 1/133

(52) U.S. Cl. 349/33

(57) ABSTRACT

A writing device for writing an image to a display medium, the writing device applies a voltage between a pair of electroconductive layers and irradiates light onto a photosensitive layer. The light irradiates onto a region of the photosensitive layer that overlaps a region of the display layer where liquid crystal of a first display layer undergoes transition to the light-reflecting state, and applies a voltage between the pair of electroconductive layers for a time period such that a voltage equal to or larger than a second threshold voltage is applied to a region of the display layer unit where the liquid crystal of the first display layer is to undergo transition to the light-reflecting state, and a voltage smaller than the second threshold voltage is applied to a region of the display layer unit overlapped by a region of the photosensitive layer to which no light is irradiated.

### CROSS-REFERENCE TO RELATED APPLICATIONS

This application is based on and claims priority under 35 U.S.C. 119 from Japanese Patent Application No. 2009-285050, which was filed on Dec. 16, 2009.

### BACKGROUND

1. Technical Field

The present invention relates to a writing device.

2. Related Art

A writing device writes an image to a display medium having a display layer and a photoconductive layer disposed between a pair of electrodes. The display layer typically contains a cholesteric liquid crystal.

### SUMMARY

In one aspect of the present invention, there is provided a writing device for writing an image to a display medium, the display medium containing (a) a display layer unit that includes a first display layer, the first display layer having a liquid crystal that undergoes transition to a light-transmissive state when a voltage equal to or larger than a first threshold voltage and smaller than a second threshold voltage is applied to the display layer unit at least for a predetermined first time period, and that undergoes transition to a light-reflecting state when a voltage equal to or larger than the second threshold voltage is applied to the display layer unit at least for a predetermined second time period that is shorter than the first time period, after which the voltage is decreased to a predetermined voltage smaller than the first threshold voltage, (b) a pair of electroconductive layers between which a voltage is applied, the pair of electroconductive layers sandwiching the display layer unit therebetween, and (c) a photosensitive layer interposed between the pair of electroconductive layers, wherein when light is irradiated onto a portion of the photosensitive layer, an electric resistance of the light-irradiated portion of the photosensitive layer decreases in accordance with an intensity of the light, the writing device including: a voltage-applying unit that applies a voltage between the pair of electroconductive layers; and a light-irradiating unit that irradiates light onto the photosensitive layer, wherein the light-irradiating unit irradiates light onto a region of the photosensitive layer that overlaps a region of the display layer unit where the liquid crystal of the first display layer is to undergo transition to the light-reflecting state, and the voltage-applying unit applies a voltage between the pair of electroconductive layers for a time period equal to or longer than the second time period and shorter than the first time period, such that a voltage equal to or larger than the second threshold voltage is applied to the region of the display layer unit where the liquid crystal of the first display layer is to undergo transition to the light-reflecting state, and a voltage smaller than the second threshold voltage is applied to a region of the display layer unit overlapped by a region of the photosensitive layer to which no light is irradiated.

### BRIEF DESCRIPTION OF THE DRAWINGS

Exemplary embodiments of the present invention will be described in detail based on the following figures, wherein:

FIG. 1 shows an outer appearance of a writing device and a display device according to an exemplary embodiment of the present invention;

FIG. 2 is a schematic view showing a cross-section of display medium 21;

FIG. 3 shows a relationship between a voltage applied to a display layer unit and a normalized light reflectivity of each display layer included in the display layer unit;

FIG. 4 is a block diagram showing a hardware structure of writing device 1;

FIG. 5 shows an example of an image displayed on display medium 21;

FIGS. 6A-6D each show an example of an image displayed on display medium 21;

FIG. 7 shows a relationship between a divisional voltage applied to the display layer unit and an alignment state of cholesteric liquid crystal;

FIG. 8 shows a relationship between a divisional voltage applied to the display layer unit and an alignment state of cholesteric liquid crystal;

FIG. 9 shows a relationship between a divisional voltage applied to the display layer unit and an alignment state of cholesteric liquid crystal;

FIG. 10 shows a relationship between a divisional voltage applied to the display layer unit and an alignment state of cholesteric liquid crystal;

FIG. 11 is a schematic view showing a cross-section of display medium 21 according to a modified embodiment;

FIG. 12A shows a relationship between a voltage applied to display layer 204R and a normalized light reflectivity of display layer 204R and FIG. 12B shows a relationship between a voltage applied to a stack of display layers 204G, 204B and a normalized light reflectivity of each display layer; and

FIG. 13 shows a relationship between a voltage applied to a stack of display layers 204R, 204G, 204B and a normalized light reflectivity of each display layer.

### DETAILED DESCRIPTION

### Exemplary Embodiment

### (Overall Configuration)

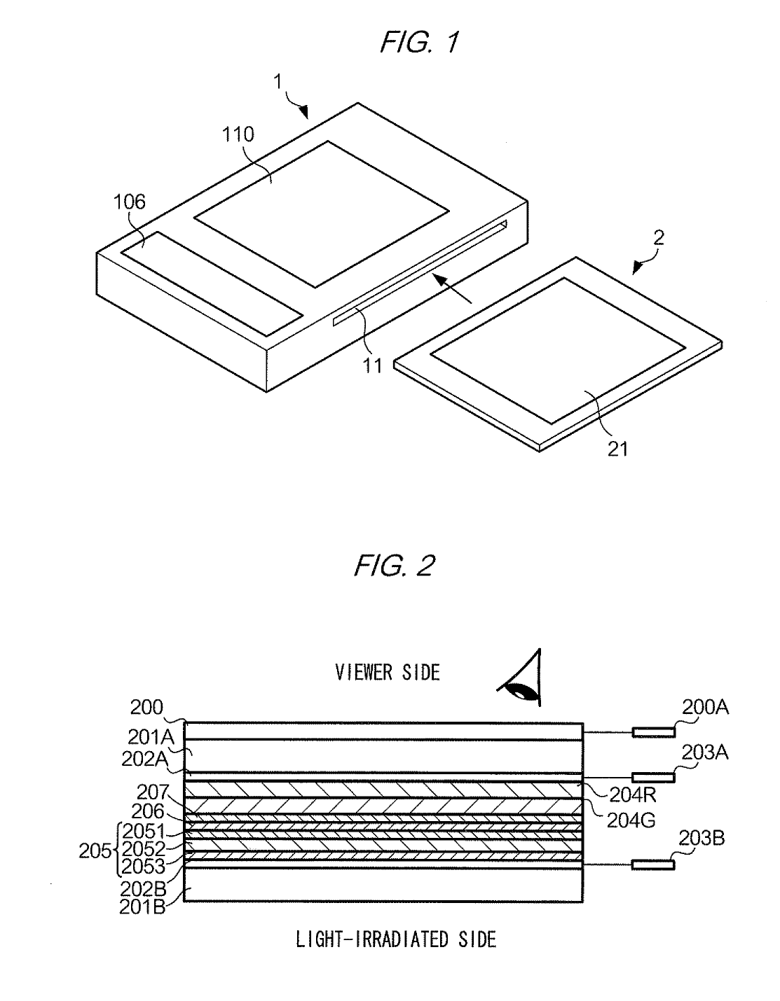

FIG. 1 shows an outer appearance of writing device 1 and display device 2 according to an exemplary embodiment of the present invention. Display device 2 is a reflection-type display device that displays an image by reflecting external light such as sunlight or light emitted from a lighting device. Display device 2 includes display medium 21 constituted by stacking a display layer having a cholesteric liquid crystal, a photosensitive layer having an organic photo conductor that generates electric charge in response to light, and a pair of electroconductive layers sandwiching the display layer and the photosensitive layer therebetween. In display device 2, when light is irradiated onto the photosensitive layer in a state where a voltage is applied between the electroconductive layers, an alignment state of the cholesteric liquid crystal in the display layer changes according to a position where light is irradiated. Thus, by controlling of the position of light irradiation, the cholesteric liquid crystal can be divided into a part that allows external light to pass therethrough and a part that reflects external light, to thereby display an image.

Writing device 1 is a device for writing an image to display medium 21. Writing device 1 has slot 11 into which display device 2 is inserted. Writing device 1 writes an image to display device 2 inserted into an inside of writing device 1 through slot 11. Glass plate 110 is a transparent glass plate. Through glass plate 11, a user of writing device 1 can view display medium 21 of display device 2 placed inside of writing device 1. Further, writing device 1 is provided with terminals for electric connection with the electroconductive layers of display device 2 and a unit for irradiating light onto the photosensitive layer of display device 2. Writing device 1 irradiates light onto display device 2 while applying a voltage to the electroconductive layers of display device 2 via the terminals, to cause display device 2 to display an image.

### (Configuration of Display Device 2)

FIG. 2 is a schematic drawing showing a cross-section of display medium 21 of display device 2. Display medium 21 is constituted of a stack of substrate layers, electroconductive layers, display layers, a colored layer, a photosensitive layer and a laminate layer. In display medium 21, a side on which substrate layer 201A is disposed is a side where an image to be viewed by a user is displayed (hereinafter referred to as a viewer side), and a side on which substrate layer 201B is disposed is a side irradiated by light output from writing device 1 (hereinafter referred to as a light-irradiated side). Display device 2 is inserted into slot 11 with the light-irradiated side facing downward.

Substrate layers 201A, 201B are layers for protecting an image-displaying portion of display medium 21 and supporting a shape of the same. Each substrate layer 201A, 201B is exposed to a corresponding surface of display device 2. In this exemplary embodiment, each substrate layer is made of polyethylene terephthalate, but the material constituting each substrate layer is not limited to polyethylene terephthalate, and can be another material having a light-transmitting property and an electrically insulating property.

In this exemplary embodiment, electroconductive layers 202A, 202B are made of indium tin oxide. Each electroconductive layer 202A, 202B is transparent and has electric conductivity. The material for constituting electroconductive layers 202A, 202B is not limited to indium tin oxide, and can be another material having a light-transmitting property and electric conductivity. In FIG. 2, electroconductive layer 202A is in contact with a surface of substrate layer 201A facing toward the light-irradiated side, and electroconductive layer 202B is in contact with a surface of substrate layer 201B facing toward the viewer side. Electroconductive layer 202A is connected to terminal 203A, and electroconductive layer 202B is connected to terminal 203B. Terminals 203A, 203B are supplied with a voltage from writing device 1. Terminals 203A, 203B are arranged to be exposed to a surface of display device 2.

Display layer 204R contacting a surface of electroconductive layer 202A facing toward the light-irradiated side, and display layer 204G contacting a surface of display layer 204R facing toward the light-irradiated side are layers constituted of plural materials such as a cholesteric liquid crystal, light-transmissive resin, etc. Each display layer has a structure such that the cholesteric liquid crystal is dispersed in the resin. Molecules of a cholesteric liquid crystal are helically aligned and the alignment state changes depending on an applied voltage. Thus, in response to an applied voltage, a cholesteric liquid crystal undergoes transition to a state for reflecting light of a specific wavelength or to a state for allowing light to pass therethrough. In this exemplary embodiment, the cholesteric liquid crystal of display layer 204G is adjusted to reflect green light (light having a wavelength in a range from 500 nm to 600 nm), and the cholesteric liquid crystal of display layer 204R is adjusted to reflect red light (light having a wavelength in a range from 600 nm to 700 nm). It is to be noted that green light and red light are mere examples, and the light reflected from each display layer is not limited thereto. The material of the cholesteric liquid crystal of each display layer may be selected such that different display layers reflect light of predetermined different wavelength ranges. The resin used in each display layer functions to hold the cholesteric liquid crystal in position to suppress any change in an image. The resin used in each display layer is strong enough to withstand an external force and is transmissive to light.

In this exemplary embodiment, a stack of display layer 204R and display layer 204G constitutes a display layer unit.

Photosensitive layer 205 is in contact with a surface of electroconductive layer 202B facing toward the viewer side and, in this exemplary embodiment, includes electric charge generation layers 2051, 2053 that generate electric charge and electric charge transportation layer 2052 that transports electric charge. Photosensitive layer 205 is constituted of electric charge generation layer 2051, electric charge transportation layer 2052, and electric charge generation layer 2053 stacked in this order from the viewer side. When light is irradiated onto photosensitive layer 205, an electric resistance of the portion of photosensitive layer 205 irradiated with light is reduced. A voltage applied to the pair of electroconductive layers, between which the display layer unit and the photosensitive layer are sandwiched, is divided between display layer unit and the photosensitive layer, and thus, if an electric resistance of a portion of the photosensitive layer is decreased, the ratio of voltage applied to the photosensitive layer to the voltage applied to the display layer unit changes such that the voltage applied to the display layer unit is increased.

Colored layer 206 is positioned to contact a surface of photosensitive layer 205 facing toward the viewer side and absorbs light. Colored layer 206 is colored with an inorganic pigment, an organic dye or an organic pigment. Laminate layer 207 is disposed between colored layer 206 and display layer 204G to serve to adhere the display layer to the colored layer and absorbs surface irregularities of these layers. As a material of laminate layer 207, a high polymer is selected that has a low glass transition temperature and is able to cause adherence between the display layer and the photosensitive layer in a close contact state when a heat and/or a pressure is applied. Also, laminate layer 207 is transmissive at least to incident light. The material used for laminate layer 207 may be an adhesive high polymer such as urethane resin, epoxy resin, acrylic resin, or silicone resin.

In display medium 21 constituted of the above-explained layers, the cholesteric liquid crystal in the display layers undergoes transition from a planar state to a focal-conic state and from a focal-conic state to a homeotropic state as an applied voltage increases, in a case where the initial state before application of a voltage is a planar state.

If the initial state before application of a voltage is the focal-conic state, the cholesteric liquid crystal changes to the homeotropic state with an increase in an applied voltage. If the voltage application is stopped when the cholesteric liquid crystal is in the focal-conic state, the cholesteric liquid crystal remains in the focal-conic state. Also, if the voltage application is stopped when the cholesteric liquid crystal is in the homeotropic state, the alignment state changes from the homeotropic state to the planar state, and the cholesteric liquid crystal stays in the planar state.

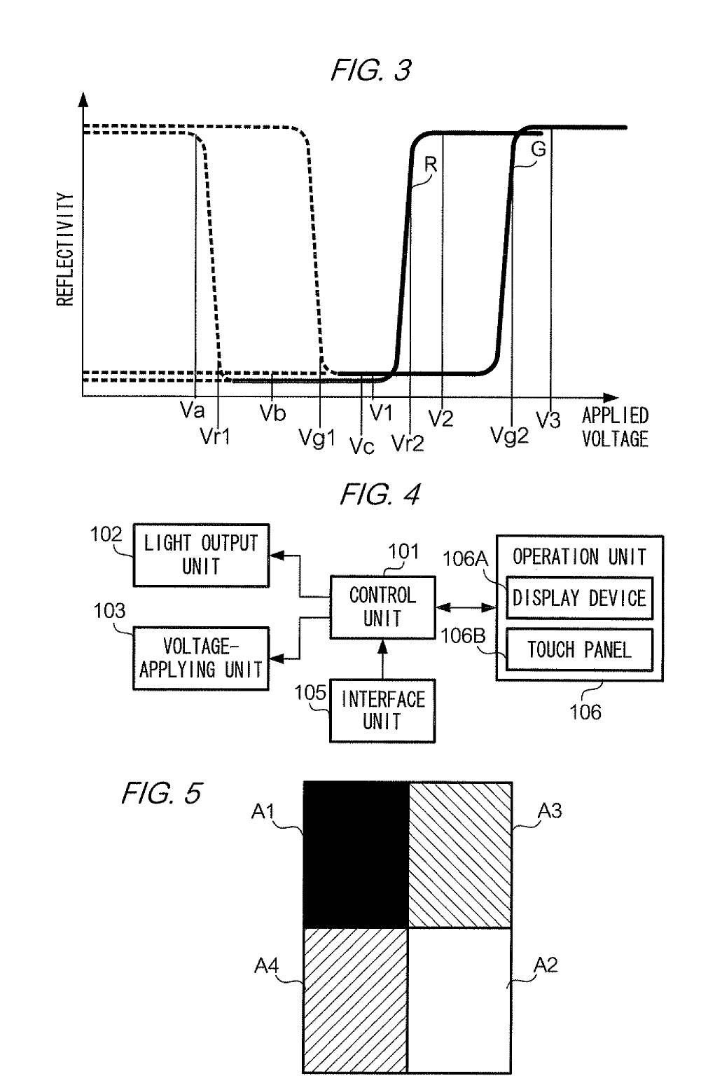

FIG. 3 shows a relationship between a voltage applied to the display layer unit via the electroconductive layers and the photosensitive layer and a normalized light reflectivity of each display layer. Curved line G in FIG. 3 represents a relationship between an applied voltage and a normalized light reflectivity of display layer 204G. Curved line R in FIG. 3 represents a relationship between an applied voltage and a normalized light reflectivity of display layer 204R.

Provided that Vg1 represents a threshold voltage for a transition of cholesteric liquid crystal of display layer 204G from the planar state to the focal-conic state and Vg2 represents a threshold voltage for a transition of the same from the focal-conic state to the homeotropic state, in a case where the voltage applied to the display layer unit via the electroconductive layers and the photosensitive layer is equal to or larger than Vg2 before termination of the voltage application, the cholesteric liquid crystal of display layer 204G will be in the planar state after the voltage application is terminated, to reflect green light contained in external light. On the other hand, in a case where the voltage applied to the display layer unit via the electroconductive layers and the photosensitive layer is equal to or larger than Vg1 and smaller than Vg2 before termination of the voltage application, the cholesteric liquid crystal of display layer 204G will be in the focal-conic state after the voltage application is terminated, to allow external light to pass therethrough.

Also, provided that Vr1 represents a threshold voltage for a transition of cholesteric liquid crystal of display layer 204R from the planar state to the focal-conic state and Vr2 represents a threshold voltage for a transition of the same from the focal-conic state to the homeotropic state, in a case where the voltage applied to the display layer unit via the electroconductive layers and the photosensitive layer is equal to or larger than Vr2 before termination of the voltage application, the cholesteric liquid crystal of display layer 204R will be in the planar state after the voltage application is terminated, to reflect red light contained in external light. On the other hand, in a case where the voltage applied to the display layer unit via the electroconductive layers and the photosensitive layer is equal to or larger than Vr1 and smaller than Vr2 before termination of the voltage application, the cholesteric liquid crystal of display layer 204R will be in the focal-conic state after the voltage application is terminated, to allow external light to pass therethrough.

As described in the foregoing, the cholesteric liquid crystal in each display layer undergoes transition to the focal-conic state when an applied voltage becomes equal to or greater than a threshold voltage for a transition from the planar state to the focal-conic state (Vr1, Vg1; hereinafter referred to as a lower threshold voltage). Also, the cholesteric liquid crystal in each display layer undergoes transition to the homeotropic state when an applied voltage becomes equal to or greater than a threshold voltage for a transition from the focal-conic state to the homeotropic state (Vr2, Vg2; hereinafter referred to as an upper threshold voltage), and further undergoes transition to the planar state when the voltage application is terminated.

It is to be noted that in this exemplary embodiment, the lower threshold voltage for display layer 204R is smaller than the lower threshold voltage for display layer 204G, and the upper threshold voltage for display layer 204R is smaller than the upper threshold voltage for display layer 204G. In the present specification, a display layer having a smaller value of lower threshold voltage is referred to as a first display layer, and a display layer having a larger value of lower threshold voltage is referred to as a second display layer. Further, the lower threshold voltage of the first display layer is referred to as a first threshold voltage, the upper threshold voltage of the first display layer is referred to as a second threshold voltage, the lower threshold voltage of the second display layer is referred to as a third threshold voltage, and the upper threshold voltage of the second display layer is referred to as a fourth threshold voltage.

The time period required to cause alignment-state transition of the cholesteric liquid crystal is different between the transition from the planar state to the focal-conic state and the transition from the focal-conic state to the homeotropic state. In the exemplary embodiment, to cause transition of the cholesteric liquid crystal from the planar state to the focal-conic state, it is necessary to apply a voltage between the lower threshold value and the upper threshold value for 100 ms or more. On the other hand, to cause transition of the cholesteric liquid crystal from the focal-conic state to the homeotropic state, it is necessary to apply a voltage equal to or larger than the upper threshold value for 10 ms or more. It is noted, however, that the time period required for alignment-state transition is not limited to the above time periods, and can be another time period depending on a kind of cholesteric liquid crystal or other factors.

### (Configuration of Writing Device 1)

FIG. 4 is a block diagram showing a hardware structure of writing device 1. Light output unit 102 has a function of irradiating light onto display medium 21. Light output unit 102 is controlled by control unit 101, and irradiates light onto photosensitive layer 205 through the light-irradiated side of display medium 21. Thus, light output unit 102 is an example of a light irradiation unit that irradiates light onto the photosensitive layer. Concretely, light output unit 102 includes a liquid crystal display device, which contains a transmission-type liquid crystal having plural pixels and a backlight unit serving as a light source. The light emitted from the backlight unit passes through the liquid crystal panel toward the light-irradiated side (underside in FIG. 2) of display medium 21. It is to be noted that the liquid crystal display device is controlled by control unit 101 to select pixels through which light passes to be output.

Control unit 101 has a so-called microcomputer having a CPU (Central Processing Unit), a ROM (Read Only Memory), a RAM (Random Access Memory), an input port, an output port, etc. The ROM stores a control program for controlling various units. Upon execution of the control program by the CPU, Control unit 101 controls various units of writing device 1 in accordance with an operation input through operation unit 106. Also, by executing the control program, control unit 101 achieves a function of overwriting an additional image to display medium 21.

Voltage-applying unit 103 has a terminal for connection with terminal 203A and a terminal for connection with terminal 203B. Further, voltage-applying unit 103 is equipped with a voltage generator. Voltage-applying unit 103 applies the voltage generated by the voltage generator to electroconductive layers 202A, 202B via terminals 203A, 203B, respectively. The voltage applied to electroconductive layers 202A, 202B from voltage-applying unit 103 is controlled by control unit 101.

Interface unit 105 serves as an interface for communication with a computer device such as a personal computer. Interface unit 105 is connected to a personal computer by means of a communications cable, and receives image data representing an image from the personal computer. The image data received from the personal computer is stored in the RAM.

Operation unit 106 includes display device 106A that displays an image, and touch panel 106B, which is transparent and is disposed on a surface of display device 106A. Display device 106A is constituted of a liquid crystal display device, for example, and displays a screen for allowing a user to operate writing device 1. Touch panel 106B provides control unit 101 with a signal that indicates a location selected by the user.

### (Operation of the Exemplary Embodiment)

### (Writing of an Image to an Entire Part of Display Medium 21)

First, display device 2 is inserted into slot 11 of writing device 1 by a user. As a result, voltage-applying unit 103 of writing device 1 is electrically connected to terminals 203A, 203B of display device 2. Then, when the user inputs an instruction through operation unit 106 for writing an image represented by image data stored in the RAM to an entire part of display medium 21, the process described below is executed.

Control unit 101 controls light output unit 102 and voltage-applying unit 103 to cause display medium 21 to display the image represented by the image data. Concretely, in a state that light output unit 102 is not irradiating light onto display medium 21, control unit 101 controls voltage-applying unit 103 to apply a voltage between terminals 203A, 203B such that an effective value of a divisional voltage applied to the display layer unit constituted of a stack of display layer 204R and display layer 204G becomes a certain value between Vr2 and Vg2 (V2 in FIG. 3). As a result, the cholesteric liquid crystal in display layer 204R enters a homeotropic alignment state, and the cholesteric liquid crystal in display layer 204G enters a focal-conic alignment state.

Next, control unit 101 controls light output unit 102 in accordance with the image represented by the image data, such that light is irradiated onto portions of display medium 21 that are to exhibit green and onto portions of display medium 21 that are to exhibit yellow. The light output from light output unit 102 reaches photosensitive layer 205. At portions of photosensitive layer 205 where light reaches, the electric resistance decreases, and this changes a ratio of the divisional voltage applied to the display layer unit to the divisional voltage applied to photosensitive layer 205, and as a result, the effective value of the divisional voltage applied to the display layer unit is increased to be equal to or larger than Vg2. In portions of display layer 204G where the effective value of the applied voltage is increased, the cholesteric liquid crystal undergoes transition to the homeotropic state. Thereafter, control unit 101 controls voltage-applying unit 102 to terminate the voltage application to the electroconductive layers. Further, control unit 101 controls light output unit 102 to terminate the irradiation of light onto photosensitive layer 205. Upon termination of voltage application to the electroconductive layers and irradiation of light onto photosensitive layer 205, the portions of the cholesteric liquid crystal of each display layer that have been brought into the homeotropic state undergo transition to the planar state.

Subsequently, control unit 101 controls voltage-applying unit 103 to apply a voltage between terminals 203A, 203B such that the effective value of the divisional voltage applied to the display layer unit becomes equal to a specific value smaller than Vr1 (Va in FIG. 3). In this state, portions of the cholesteric liquid crystal of each of display layer 204G and display layer 204R remain in the same alignment state as that when application of voltage V2 to the display layer unit is terminated. Then, control unit 101 controls light output unit 102 such that light is irradiated onto portions of display medium 21 that are to exhibit black and onto portions of display medium 21 that are to exhibit green. The light output from light output unit 102 reaches photosensitive layer 205. At portions of photosensitive layer 205 reached by the light, the electric resistance decreases, and this changes a ratio of the divisional voltage applied to the display layer unit to the divisional voltage applied to photosensitive layer 205, and as a result, the effective value of the divisional voltage applied to the display layer unit is increased to a value between Vr1 and Vg1 (Vb in FIG. 3). In portions of display layer 204R where the effective value of the applied voltage is increased, the cholesteric liquid crystal undergoes transition to the focal-conic state. On the other hand, in portions of display layer 204R where the effective value of the applied voltage is not increased, the cholesteric liquid crystal remains in the same alignment state as that prior to the application of voltage Va. In display layer 204G, irrespective of the change in the effective value of the divisional voltage owing to the light irradiation, the cholesteric liquid crystal remains in the same alignment state as that prior to the application of voltage Va.

FIG. 5 is an example of an image displayed by display medium 21 as a result of the foregoing operation. In a region where the cholesteric liquid crystal is in the focal-conic state in each of display layer 204R and display layer 204G, light entering from the viewer side passes through each display layer and is absorbed by colored layer 206, and thus this region exhibits black (region A1 in FIG. 5). In a region where the cholesteric liquid crystal is in the planar state in each of display layer 204R and display layer 204G, a red component of light entering from the viewer side is reflected by display layer 204R and a green component of the same is reflected by display layer 204G, and thus this region exhibits yellow (region A2 in FIG. 5). In a region where the cholesteric liquid crystal is in the planar state in display layer 204R and is in the focal-conic state in display layer 204G, a red component of light entering from the viewer side is reflected by display layer 204R and the other component of the incident light passes through display layer 204G, and thus this region exhibits red (region A3 in FIG. 5). Further, in a region where the cholesteric liquid crystal is in the focal-conic state in display layer 204R and is in the planar state in display layer 204G, a green component of light entering from the viewer side is reflected by display layer 204G and the other component of the incident light passes through display layer 204R, and thus this region exhibits green (region A4 in FIG. 5).

Thereafter, when the user inputs an instruction through operation unit 106 for overwriting an additional image represented by image data stored in the RAM to display medium 21, the process described below is executed.

### (Operation for Overwriting an Additional Image to a Region Exhibiting Black)

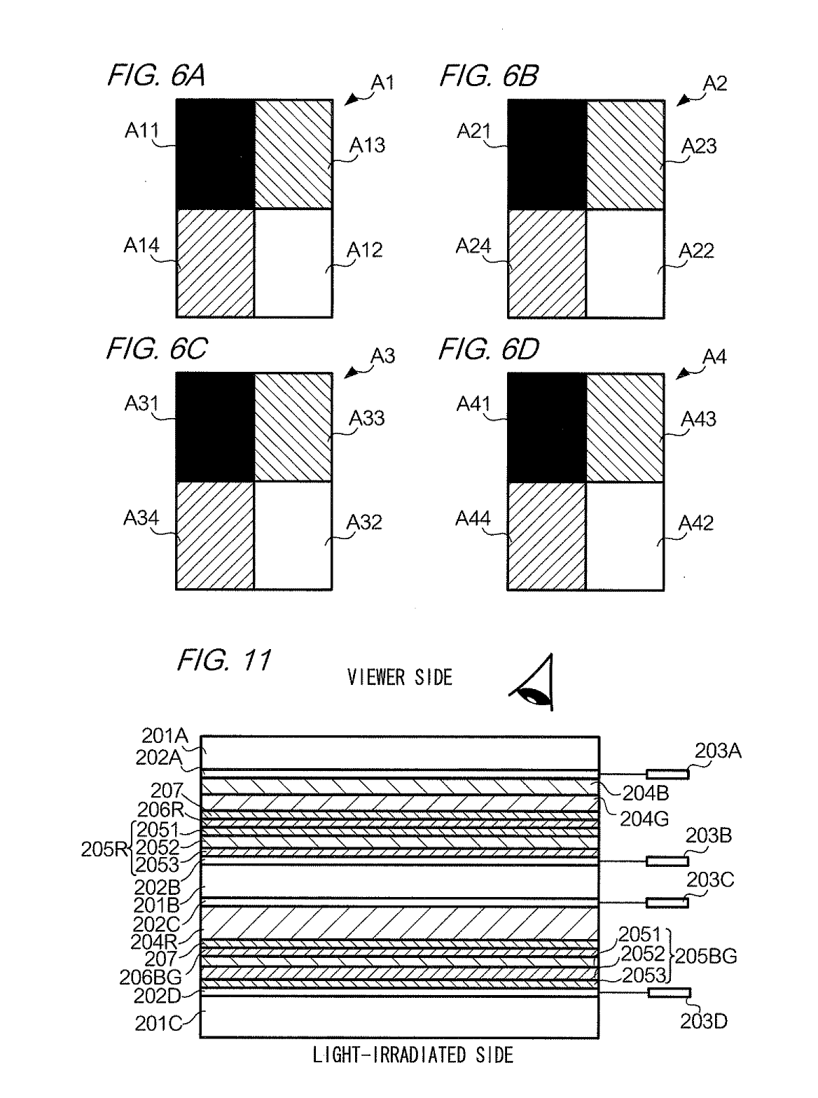

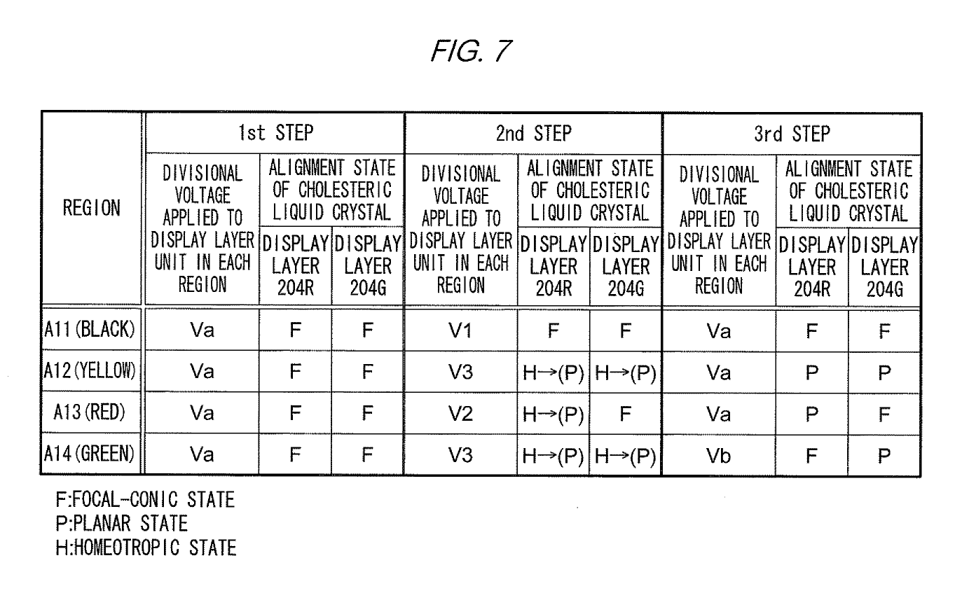

Explanation will now be made of a case where sub-region A12 exhibiting yellow, sub-region A13 exhibiting red, and sub-region A14 exhibiting green are overwritten on black color region A1, as shown in FIG. 6A (a portion of region A1 that remains black is referred to as sub-region A11). When writing an additional image to display medium 21, writing device 1 controls the alignment state of the cholesteric layer in each display layer in three steps. FIG. 7 shows, for each step, the divisional voltage applied to the display layer unit in respective sub-regions A11-A14, and the alignment state of the cholesteric liquid crystal of each display layer in respective sub-regions A11-A14. In the first step, control unit 101 controls voltage-applying unit 103 to apply a voltage between terminals 203A, 203B such that the effective value of the divisional voltage applied to the display layer unit (or the stack of display layer 204R and display layer 204G) becomes equal to Va. Further, control unit 101 controls light output unit 102 such that light is not irradiated onto sub-regions A11-A14. Because light is not irradiated onto sub-regions A11-A14, the divisional voltage applied to the display layer unit in sub-regions A11-A14 remains at voltage Va. Thus, the cholesteric liquid crystal of each display layer remains in the focal-conic state in each sub-region A11-A14, as shown in FIG. 7. Thereafter, control unit 101 controls voltage-applying unit 103 to terminate the voltage application.

Next, in the second step, control unit 101 controls light output unit 102 such that light of a first luminous intensity is irradiated onto sub-region A13, light of a second luminous intensity, which is larger than the first luminous intensity, is irradiated onto sub-region A14 and sub-region A12, and no light is irradiated onto sub-region A11. Then, control unit 101 controls voltage-applying unit 103 to apply a voltage between terminals 203A, 203B (or between electroconductive layers 202A, 202B) such that a divisional voltage is applied to the display layer unit. The voltage applied between terminals 203A, 203B is selected such that a voltage between Vg1 and Vr2 (V1 in FIG. 3) is applied to the display layer unit in portions where no light is irradiated onto corresponding (or overlapping) portions of photosensitive layer 205 (such as sub-region A11). It is to be noted here that a time period during which the voltage is applied is shorter than a time period required for causing the cholesteric liquid crystal in the planar state to undergo transition to the focal-conic state (hereinafter referred to as a first time period) and longer than a time period required for causing the cholesteric liquid crystal in the focal-conic state to undergo transition to the homeotropic state (hereinafter referred to as a second time period).

Upon application of voltage from voltage-applying unit 103, a voltage between Vr2 and Vg2 (V2 of FIG. 3) is applied to the display layer unit in sub-region A13, where display medium 21 is irradiated with light of the first luminous intensity. Accordingly, in sub-region A13, the cholesteric liquid crystal of display layer 204R undergoes transition to the homeotropic state and the cholesteric liquid crystal of display layer 204G remains in the focal-conic state, as shown in FIG. 7. In sub-region A12 and sub-region A14, where display medium 21 is irradiated with light of the second luminous intensity, a voltage equal to or larger than Vg2 (V3 in FIG. 3) is applied to the display layer unit. Accordingly, in sub-regions A12 and A14, the cholesteric liquid crystal of each display layer 204R, 204G undergoes transition to the homeotropic state. Thereafter, control unit 101 controls voltage-applying unit 103 to terminate the voltage application to electroconductive layers 202A, 202B. Further, control unit 101 controls light output unit 102 to terminate the light irradiation onto display medium 21. Upon termination of voltage application, the cholesteric liquid crystal in the homeotropic state undergoes transition to the planar state.

It is to be noted that in the second step, the time period of voltage application from voltage-applying unit 103 is shorter than the time period required for causing the cholesteric liquid crystal in the planar state to undergo transition to the focal-conic state. Therefore, though a voltage is applied to electroconductive layers 202A, 202B such that voltage V1, which is larger than Vr1 and Vg1, is applied to the display layer unit in portions where no light is irradiated, the cholesteric liquid crystal that is in the planar state (such as the cholesteric liquid crystal of each display layer in region A2) and is contained in such portions (and thus is applied with voltage V1) does not undergo transition to the focal-conic state and remains in the planar state.

Subsequently, in the third step, control unit 101 controls light output unit 102 to irradiate light of the first luminous intensity onto sub-region A14. At the same time, control unit 101 controls light output unit 102 such that no light is irradiated onto sub-regions A11, A12, and A13.

Then, control unit 101 controls voltage-applying unit 103 such that a divisional voltage is applied to the display layer unit via terminals 203A, 203B. At this time, the voltage applied between terminals 203A, 203B is selected such that voltage Va is applied to the display layer unit in portions where no light is irradiated (such as in sub-regions A11, A12, and A13). Thus, when the voltage is applied from voltage-applying unit 103, the cholesteric liquid crystal in sub-regions A11, A12, and A13 remains in the same alignment state as that prior to the voltage application (i.e., either in the planar state or in the focal-conic state), as shown in FIG. 7. On the other hand, in sub-region A14, where light of the first luminous intensity is irradiated onto display medium 21, voltage Vb, which is between Vr1 and Vg1, is applied to the display layer unit. Accordingly, the cholesteric liquid crystal of display layer 204R in sub-region A14 undergoes transition to the focal-conic state. It is to be noted that in this third step, the time period of voltage application is longer than the first time period. Thereafter, control unit 101 controls voltage-applying unit 103 to terminate the voltage application to electroconductive layers 202A, 202B. Further, control unit 101 controls light output unit 102 to terminate irradiation of light onto display medium 21.

In the state after completion of the third step, in sub-region A11, the cholesteric liquid crystal of each display layer is still in the focal-conic state, and thus, sub-region A11 appears black to a user. In sub-region A12, the cholesteric liquid crystal in each display layer 204R, 204G has been brought into the planar state, and thus, sub-region A12 appears yellow to a user. In sub-region A13, the cholesteric liquid crystal of display layer 204G has remained in the focal-conic state and the cholesteric liquid crystal of display layer 204R has been brought into the planar state, and thus, sub-region A13 appears red to a user. Further, in sub-region A14, the cholesteric liquid crystal of display layer 204G has been brought into the planar state and the cholesteric liquid crystal of display layer 204R has been eventually brought into the focal-conic state, and thus, sub-region A14 appears green to a user.

### (Operation for Overwriting an Additional Image to a Region Exhibiting Yellow)

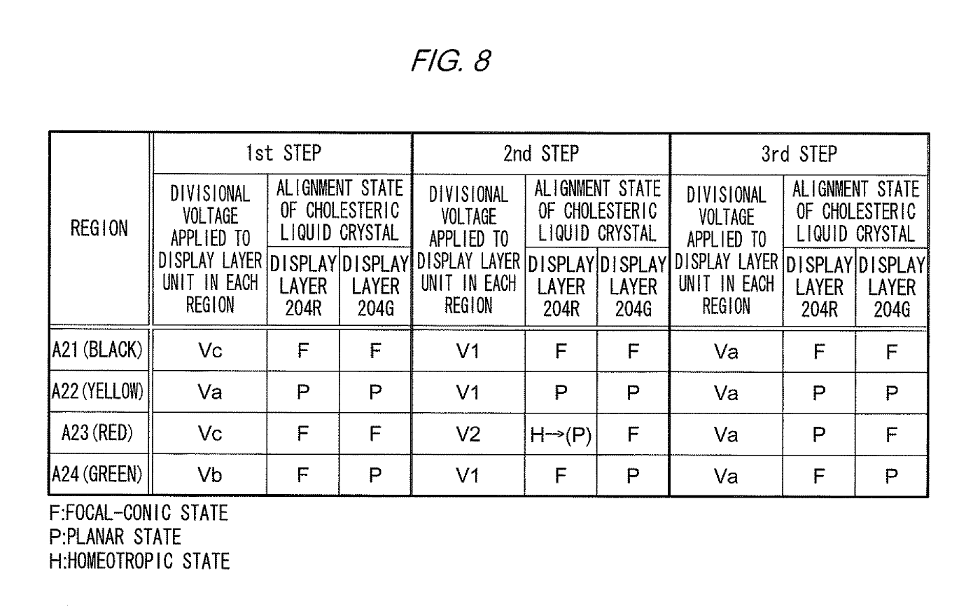

Explanation will now be made of a case where sub-region A21 exhibiting black, sub-region A23 exhibiting red, and sub-region A24 exhibiting green are overwritten on yellow color region A2, as shown in FIG. 6B (a portion of region A2 that remains yellow is referred to as a sub-region A22). FIG. 8 shows, for each of three steps for overwriting an image on the yellow color region, the divisional voltage applied to the display layer unit in respective sub-regions A21-A24, and the alignment state of the cholesteric liquid crystal of each display layer in respective sub-regions A21-A24. In the first step, control unit 101 controls voltage-applying unit 103 to apply a voltage between terminals 203A and 203B such that the effective value of the divisional voltage applied to the display layer unit becomes equal to Va. Further, control unit 101 controls light output unit 102 such that light of the first luminous intensity is irradiated onto sub-region A24 and light of the second luminous intensity, which is larger than the first luminous intensity, is irradiated onto sub-regions A21 and A23. No light is irradiated onto sub-region A22.

In this state, the divisional voltage applied to the display layer unit in sub-region A22 remains at voltage Va. Thus, the cholesteric liquid crystal of each display layer remains in the planar state in sub-region A22, as shown in FIG. 8. In sub-region A24, where light of the first luminous intensity is irradiated, the divisional voltage applied to the display layer unit becomes equal to voltage Vb, which is larger than Vr1 and smaller than Vg1, and accordingly, the cholesteric liquid crystal of display layer 204R undergoes transition from the planar state to the focal-conic state while the alignment state of the cholesteric liquid crystal of display layer 204G does not change and remains in the planar state. In sub-regions A21 and A23, where light of the second luminous intensity is irradiated, the divisional voltage applied to the display layer unit becomes voltage Vc between Vg1 and Vr2, and the cholesteric liquid crystal in each of display layers 204R and 204G undergoes transition from the planar state to the focal-conic state. Thereafter, control unit 101 controls voltage-applying unit 103 to terminate the voltage application. Further, control unit 101 controls light output unit 102 to terminate the light irradiation onto display medium 21.

Next, in the second step, control unit 101 controls light output unit 102 such that light of the first luminous intensity is irradiated onto sub-region A23, and no light is irradiated onto sub-regions A21, A22, and A24. Then, control unit 101 controls voltage-applying unit 103 to apply a voltage between terminals 203A, 203B such that voltage V1 shown in FIG. 3 is applied to the display layer unit in portions where no light is irradiated onto corresponding (or overlapping) portions of photosensitive layer 205 (such as sub-regions A21, A22, and A24). It is to be noted here that the time period during which the voltage is applied is shorter than the first time period and longer than the second time period.

Upon application of voltage from voltage-applying unit 103, voltage V2 shown in FIG. 3 is applied to the display layer unit in sub-region A23, where display medium 21 is irradiated with light of the first luminous intensity. Accordingly, in sub-region A23, the cholesteric liquid crystal of display layer 204R undergoes transition to the homeotropic state and the cholesteric liquid crystal of display layer 204G remains in the focal-conic state, as shown in FIG. 8. In the other sub-regions, where no light is irradiated onto display medium 21, voltage V1 is applied to the display layer unit. Thereafter, control unit 101 controls voltage-applying unit 103 to terminate the voltage application to electroconductive layers 202A, 202B. Further, control unit 101 controls light output unit 102 to terminate irradiation of light onto display medium 21. Upon termination of voltage application, the cholesteric liquid crystal in the homeotropic state undergoes transition to the planar state.

As mentioned above, in the second step, the time period of voltage application from voltage-applying unit 103 is shorter than the time period required for causing the cholesteric liquid crystal in the planar state to undergo transition to the focal-conic state. Therefore, though a voltage is applied to electroconductive layers 202A, 202B such that voltage V1, which is larger than Vr1 and Vg1, is applied to the display layer unit in portions where no light is irradiated, the cholesteric liquid crystal that is in the planar state (such as the cholesteric liquid crystal of each display layer in sub-region A22 or the cholesteric liquid crystal of display layer 204G in sub-region A24) and is contained in those portions (and thus is applied with voltage V1), does not undergo transition to the focal-conic state and remains in the planar state.

Subsequently, in the third step, control unit 101 controls light output unit 102 such that no light is irradiated onto sub-regions A21-A24. Then, control unit 101 controls voltage-applying unit 103 such that a divisional voltage is applied to the display layer unit via terminals 203A, 203B. At this time, the voltage applied between terminals 203A, 203B is selected such that voltage Va is applied to the display layer unit in portions where no light is irradiated. Thus, when the voltage is applied from voltage-applying unit 103, voltage Va is applied to the display layer unit in sub-regions A21-A24, and the cholesteric liquid crystal in sub-regions A21-A24 remains in the same alignment state as that prior to the voltage application (i.e., either in the planar state or in the focal-conic state), as shown in FIG. 8.

In the state after completion of the third step, in sub-region A21, the cholesteric liquid crystal of each display layer has been brought into the focal-conic state, and thus, sub-region A21 appears black to a user. In sub-region A22, the cholesteric liquid crystal in each display layer 204R, 204G has remained in the planar state, and thus, sub-region A22 appears yellow to a user. In sub-region A23, the cholesteric liquid crystal of display layer 204G has been brought into the focal-conic state and the cholesteric liquid crystal of display layer 204R has been eventually brought into the planar state, and thus, sub-region A23 appears red to a user. Further, in sub-region A24, the cholesteric liquid crystal of display layer 204G has remained in the planar state and the cholesteric liquid crystal of display layer 204R has been brought into the focal-conic state, and thus, sub-region A24 appears green to a user.

### (Operation for Overwriting an Additional Image to a Region Exhibiting Red)

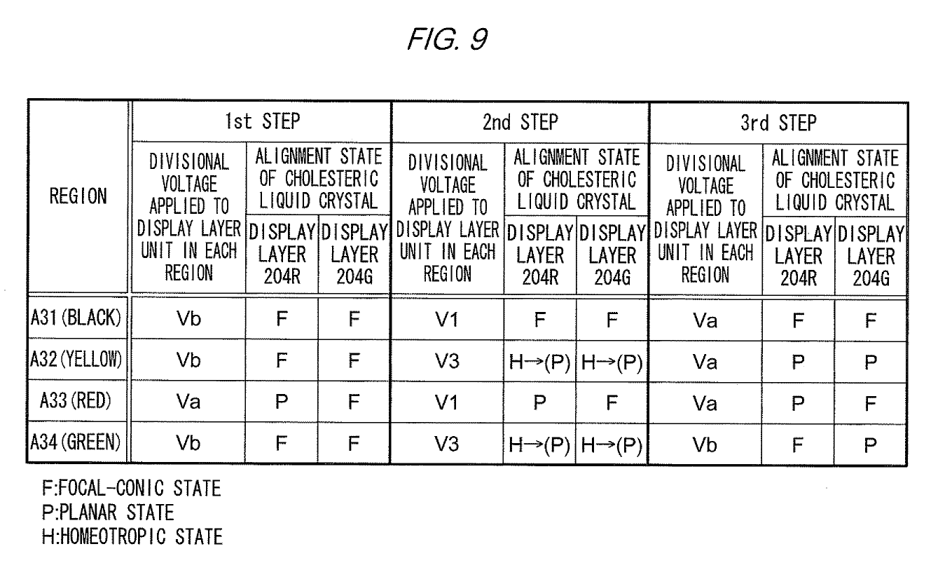

Explanation will now be made of a case where sub-region A31 exhibiting black, sub-region A32 exhibiting yellow, and sub-region A34 exhibiting green are overwritten on red color region A3, as shown in FIG. 6C (a portion of region A3 that remains red is referred to as sub-region A33). FIG. 9 shows, for each of three steps for overwriting an image on the red color region, the divisional voltage applied to the display layer unit in respective sub-regions A31-A34, and the alignment state of the cholesteric liquid crystal of each display layer in respective sub-regions A31-A34. In the first step, control unit 101 controls voltage-applying unit 103 to apply a voltage between terminals 203A, 203B such that the effective value of the divisional voltage applied to the display layer unit becomes equal to Va. Further, control unit 101 controls light output unit 102 such that light of the first luminous intensity is irradiated onto sub-regions A31, A32, and A34, and no light is irradiated onto sub-region A33.

In this state, the divisional voltage applied to the display layer unit in sub-region A33 remains at voltage Va. Thus, the cholesteric liquid crystal of each display layer in sub-region A33 remains in the same alignment state as that prior to the voltage application, as shown in FIG. 9. In sub-regions A31, A32, and A34, the divisional voltage applied to the display layer unit becomes equal to voltage Vb, and accordingly, the cholesteric liquid crystal of display layer 204R undergoes transition from the planar state to the focal-conic state. It is to be noted that in sub-regions A31, A32, and A34, because the divisional voltage applied to display layer 204G is equal to Vb, the alignment state of the cholesteric liquid crystal of display layer 204G does not change and remains in the focal-conic state. Thereafter, control unit 101 controls voltage-applying unit 103 to terminate the voltage application. Further, control unit 101 controls light output unit 102 to terminate the light irradiation onto display medium 21.

Next, in the second step, control unit 101 controls light output unit 102 such that light of the second luminous intensity is irradiated onto sub-regions A32 and A34 and no light is irradiated onto sub-regions A31 and A33. Then, control unit 101 controls voltage-applying unit 103 to apply a voltage between terminals 203A, 203B (or between electroconductive layers 202A, 202B) such that voltage V1 shown in FIG. 3 is applied to the display layer unit in portions where no light is irradiated onto corresponding (or overlapping) portions of photosensitive layer 205 (such as sub-regions A31 and A33). It is to be noted here that the time period during which the voltage is applied is shorter than the first time period and longer than the second time period.

Upon application of voltage from voltage-applying unit 103, voltage V3 shown in FIG. 3 is applied to the display layer unit in sub-regions A32 and A34, where display medium 21 is irradiated with light of the second luminous intensity. Accordingly, in sub-regions A32 and A34, the cholesteric liquid crystal of each display layer 204R, 204G undergoes transition to the homeotropic state. In the other sub-regions, where no light is irradiated onto display medium 21, voltage V1 is applied to the display layer unit. Accordingly, in sub-regions A31 and A33, the cholesteric liquid crystal of each display layer maintains the same alignment state as that prior to the voltage application. Thereafter, control unit 101 controls voltage-applying unit 103 to terminate the voltage application to electroconductive layers 202A, 202B. Further, control unit 101 controls light output unit 102 to terminate irradiation of light onto display medium 21. Upon termination of voltage application, the cholesteric liquid crystal in the homeotropic state undergoes transition to the planar state.

As mentioned above, in the second step, the time period of voltage application from voltage-applying unit 103 is shorter than the time period required for causing the cholesteric liquid crystal in the planar state to undergo transition to the focal-conic state. Therefore, though a voltage is applied to electroconductive layers 202A, 202B such that voltage V1, which is larger than Vr1 and Vg1, is applied to the display layer unit in portions where no light is irradiated, the cholesteric liquid crystal that is in the planar state (such as the cholesteric liquid crystal of display layer 204R in sub-region A33) and is contained in such portions (and thus is applied with voltage V1) does not undergo transition to the focal-conic state and remains in the planar state.

Subsequently, in the third step, control unit 101 controls light output unit 102 such that light of the first luminous intensity is irradiated onto sub-region A34 and no light is irradiated onto sub-regions A31-A33. Then, control unit 101 controls voltage-applying unit 103 such that a divisional voltage is applied to the display layer unit via terminals 203A, 203B. At this time, the voltage applied between terminals 203A, 203B is selected such that voltage Va is applied to the display layer unit in portions where no light is irradiated. Thus, when the voltage is applied from voltage-applying unit 103, voltage Va is applied to the display layer unit in sub-regions A31-A33, and the cholesteric liquid crystal in sub-regions A31-A33 remains in the same alignment state as that prior to the voltage application (i.e., either in the planar state or in the focal-conic state), as shown in FIG. 9. On the other hand, in sub-region A34, where light of the first luminous intensity is irradiated onto display medium 21, voltage Vb, which is between Vr1 and Vg1, is applied to the display layer unit. Accordingly, the cholesteric liquid crystal of display layer 204R in sub-region A34 undergoes transition to the focal-conic state. Thereafter, control unit 101 controls voltage-applying unit 103 to terminate the voltage application to electroconductive layers 202A, 202B. Further, control unit 101 controls light output unit 102 to terminate irradiation of light onto display medium 21.

In the state after completion of the third step, in sub-region A31, the cholesteric liquid crystal of display layer 204R has been brought into the focal-conic state and the cholesteric liquid crystal of display layer 204G remains in the focal-conic state, and thus, sub-region A31 appears black to a user. In sub-region A32, the cholesteric liquid crystal in each display layer 204R, 204G has been brought into the planar state, and thus, sub-region A32 appears yellow to a user. In sub-region A33, the cholesteric liquid crystal of display layer 204R has remained in the planar state and the cholesteric liquid crystal of display layer 204G has remained in the focal-conic state, and thus, sub-region A33 appears red to a user. Further, in sub-region A34, the cholesteric liquid crystal of display layer 204G has been brought into the planar state and the cholesteric liquid crystal of display layer 204R has been brought into the focal-conic state, and thus, sub-region A34 appears green to a user.

### (Operation for Overwriting an Additional Image to a Region Exhibiting Green)

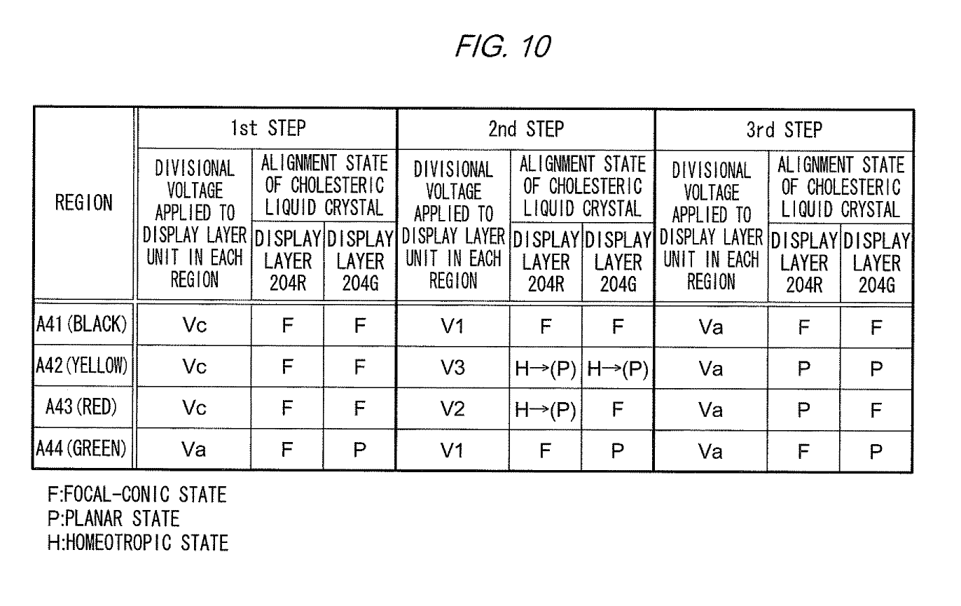

Explanation will now be made of a case where sub-region A41 exhibiting black, sub-region A42 exhibiting yellow, and sub-region A43 exhibiting red are overwritten on green color region A4, as shown in FIG. 6D (a portion of region A4 that remains green is referred to as sub-region A44). FIG. 10 shows, for each of three steps for overwriting an image on the green color region, the divisional voltage applied to the display layer unit in respective sub-regions A41-A44, and the alignment state of the cholesteric liquid crystal of each display layer in respective sub-regions A41-A44. In the first step, control unit 101 controls voltage-applying unit 103 to apply a voltage between terminals 203A, 203B such that the effective value of the divisional voltage applied to the display layer unit becomes equal to Va. Further, control unit 101 controls light output unit 102 such that light of a second luminous intensity is irradiated onto sub-regions A41-A43 and no light is irradiated onto sub-region A44.

In this state, the divisional voltage applied to the display layer unit in sub-region A44 remains at voltage Va. Thus, the cholesteric liquid crystal of each display layer in sub-region A44 remains in the same alignment state as that prior to the voltage application, as shown in FIG. 10. In sub-regions A41-A43, the divisional voltage applied to the display layer unit becomes equal to voltage Vc, and accordingly, the cholesteric liquid crystal of display layer 204G undergoes transition to the focal-conic state while the cholesteric liquid crystal of display layer 204R remains in the focal-conic state. Thereafter, control unit 101 controls voltage-applying unit 103 to terminate the voltage application. Further, control unit 101 controls light output unit 102 to terminate the light irradiation onto display medium 21.

Next, in the second step, control unit 101 controls light output unit 102 such that light of the first luminous intensity is irradiated onto sub-region A43, light of the second luminous intensity is irradiated onto sub-region A42, and no light is irradiated onto sub-regions A41 and A44. Then, control unit 101 controls voltage-applying unit 103 to apply a voltage between terminals 203A, 203B (or between electroconductive layers 202A, 202B) such that voltage V1 shown in FIG. 3 is applied to the display layer unit in portions where no light is irradiated onto corresponding (or overlapping) portions of photosensitive layer 205 (such as sub-regions A41 and A44). It is to be noted here that the time period during which the voltage is applied is shorter than the first time period and longer than the second time period.

Upon application of voltage from voltage-applying unit 103, voltage V2 shown in FIG. 3 is applied to the display layer unit in sub-region A43, where display medium 21 is irradiated with light of the first luminous intensity. Accordingly, in sub-region A43, the cholesteric liquid crystal of display layer 204R undergoes transition to the homeotropic state and the cholesteric liquid crystal of display layer 204G remains in the focal-conic state, as shown in FIG. 10. In sub-region A42, where light of the second luminous intensity is irradiated onto display medium 21, the divisional voltage applied to the display layer unit is equal to voltage V3 shown in FIG. 3. Accordingly, the cholesteric liquid crystal of each display layer 204R, 204G undergoes transition to the homeotropic state, as shown in FIG. 10. In sub-regions A41 and A44, where no light is irradiated onto display medium 21, voltage V1 is applied to the display layer unit. Accordingly, in sub-regions A41 and A44, the cholesteric liquid crystal of each display layer maintains the same alignment state as that prior to the voltage application. Thereafter, control unit 101 controls voltage-applying unit 103 to terminate the voltage application to electroconductive layers 202A, 202B. Further, control unit 101 controls light output unit 102 to terminate irradiation of light onto display medium 21. Upon termination of voltage application, the cholesteric liquid crystal in the homeotropic state undergoes transition to the planar state.

As mentioned above, in the second step, the time period of voltage application from voltage-applying unit 103 is shorter than the time period required for causing the cholesteric liquid crystal in the planar state to undergo transition to the focal-conic state. Therefore, though a voltage is applied to electroconductive layers 202A, 202B such that voltage V1, which is larger than Vr1 and Vg1, is applied to the display layer unit in portions where no light is irradiated, the cholesteric liquid crystal that is in the planar state (such as the cholesteric liquid crystal of display layer 204G in sub-region A44) does not undergo transition to the focal-conic state and remains in the planar state.

Subsequently, in the third step, control unit 101 controls light output unit 102 such that no light is irradiated onto sub-regions A41-A44. Then, control unit 101 controls voltage-applying unit 103 such that a divisional voltage is applied to the display layer unit via terminals 203A, 203B. At this time, the voltage applied between terminals 203A, 203B is selected such that voltage Va is applied to the display layer unit in portions where no light is irradiated. Thus, when the voltage is applied from voltage-applying unit 103, voltage Va is applied to the display layer unit in sub-regions A41-A44, and the cholesteric liquid crystal in sub-regions A41-A44 remains in the same alignment state as that prior to the voltage application (i.e., either in the planar state or in the focal-conic state), as shown in FIG. 10. Thereafter, control unit 101 controls voltage-applying unit 103 to terminate the voltage application to electroconductive layers 202A, 202B. Further, control unit 101 controls light output unit 102 to terminate irradiation of light onto display medium 21.

In the state after completion of the third step, in sub-region A41, the cholesteric liquid crystal of display layer 204G has been brought into the focal-conic state and the cholesteric liquid crystal of display layer 204R remains in the focal-conic state, and thus, sub-region A41 appears black to a user. In sub-region A42, the cholesteric liquid crystal in each display layer 204R, 204G has been brought into the planar state, and thus, sub-region A42 appears yellow to a user. In sub-region A43, the cholesteric liquid crystal of display layer 204R has been brought into the planar state and the cholesteric liquid crystal of display layer 204G has been brought into the focal-conic state, and thus, sub-region A43 appears red to a user. Further, in sub-region A44, the cholesteric liquid crystal of display layer 204G has remained in the planar state and the cholesteric liquid crystal of display layer 204R has remained in the focal-conic state, and thus, sub-region A44 appears green to a user.

### Modified Embodiments

In the foregoing, explanation is made of the exemplary embodiment of the present invention, but the present invention is not limited to the exemplary embodiment and can be practiced in a variety of other embodiments. For example, the above-described exemplary embodiment may be modified as described below to practice the invention. Also, the exemplary embodiment and the following modified embodiments may be combined, as necessary.

In the foregoing exemplary embodiment, the display layer unit of display medium 21 includes two display layers, i.e., display layer 204R and display layer 204G, but the display layer unit may include only a single display layer. As an example of a single display layer structure, display medium 21 may include only display layer 204G, for example. In such a structure, to locally change an alignment state of the cholesteric liquid crystal to the planar state, writing device 1 applies a voltage to the electroconductive layers such that an effective value of the divisional voltage applied to display layer 204G in portions where no light is irradiated becomes equal to voltage V2, and controls light output unit 102 to irradiate light onto the photosensitive layer such that voltage V3 is applied to a portion(s) of the cholesteric liquid crystal where the alignment state should be changed to the planar state. In this case also, a time period during which the voltage is applied from voltage-applying unit 103 is set shorter than the first time period and longer than the second time period. It is to be noted that the single display layer structure may be constituted of a structure that includes display layer 204R only. Further, in a single display layer structure, the wavelength of light reflected from the display layer may be different from the wavelength of light reflected by display layer 204R or 204G.

In the foregoing exemplary embodiment, display medium 21 includes two display layers, i.e., display layer 204R and display layer 204G, but display medium 21 may include three display layers. FIG. 11 is a schematic view showing a cross-section of display medium 21 including three display layers. Substrate layers 201A, 201B, 201C are layers for protecting an image-displaying portion of display medium 21 and supporting a shape of the same. Each substrate layer is made of the same material as the substrate layers of the above-described exemplary embodiment. In this modified embodiment, substrate layers 201A, 201C are exposed to corresponding surfaces of display device 2. Substrate layer 201B functions to provide electrical insulation between electroconductive layers 202B and 202C.

Each electroconductive layer 202A, 202B, 202C, 202D is a layer that is transparent and has electric conductivity. Electroconductive layer 202A is in contact with a surface of substrate layer 201A facing toward the light-irradiated side. Electroconductive layer 202B is in contact with a surface of substrate layer 201B facing toward the viewer side. Electroconductive layer 202C is in contact with a surface of substrate layer 201B facing toward the light-irradiated side. Electroconductive layer 202D is in contact with a surface of substrate layer 201C facing toward the viewer side. Further, electroconductive layer 202A is connected to terminal 203A, electroconductive layer 202B to terminal 203B, electroconductive layer 202C to terminal 203C, and electroconductive layer 202D to terminal 203D. Terminals 203A-203D are supplied with a voltage from writing device 1, and are arranged to be exposed to a surface(s) of display device 2.

Each display layer 204B, 204G, 204R is a layer constituted of plural materials such as a cholesteric liquid crystal, light-transmissive resin, etc., and has such a structure that the cholesteric liquid crystal is dispersed in the resin. Display layer 204B is in contact with a surface of electroconductive layer 202A facing toward the light-irradiated side, display layer 204G is in contact with a surface of display layer 204B facing toward the light-irradiated side, and display layer 204R is in contact with a surface of electroconductive layer 202C facing toward the light-irradiated side. In this modified embodiment, display layer 204R and display layer 204G have the same structure as described in the foregoing with respect to the exemplary embodiment. The cholesteric liquid crystal of display layer 204B is adjusted to reflect blue light (light having a wavelength in a range of 400 nm-500 nm).

Like photosensitive layer 205 of the above-described exemplary embodiment, each photosensitive layer 205R, 205BG is constituted of electric charge generation layer 2051, electric charge transportation layer 2052, and electric charge generation layer 2053 stacked in this order from the viewer side. Photosensitive layer 205R is in contact with a surface of electroconductive layer 202B facing toward the viewer side, and photosensitive layer 205R is in contact with a surface of electroconductive layer 202D facing toward the viewer side.

Colored layer 206R is a layer that absorbs light having the same wavelength as the light absorbed by the charge generation layer of photosensitive layer 205R. Colored layer 206R is colored with an inorganic pigment, an organic dye or an organic pigment, to assume a color complementary to the color of light reflected by display layers 204B, 204G Colored layer 206R is in contact with a surface of photosensitive layer 205R facing toward the viewer side. Colored layer 206BG is a layer that absorbs light having the same wavelength as the light absorbed by the charge generation layer of photosensitive layer 205BG, and is colored with an inorganic pigment, an organic dye or an organic pigment, to assume a color complementary to the color of light reflected by display layers 204R. Colored layer 206BG is in contact with a surface of photosensitive layer 205BG facing toward the viewer side.

Laminate layer 207 is made of the same material as laminate layer 207 of the above-described exemplary embodiment. In this modified embodiment, two laminate layers 207 are disposed; one between colored layer 206R and display layer 204G and the other between colored layer 206BG and display layer 204R.

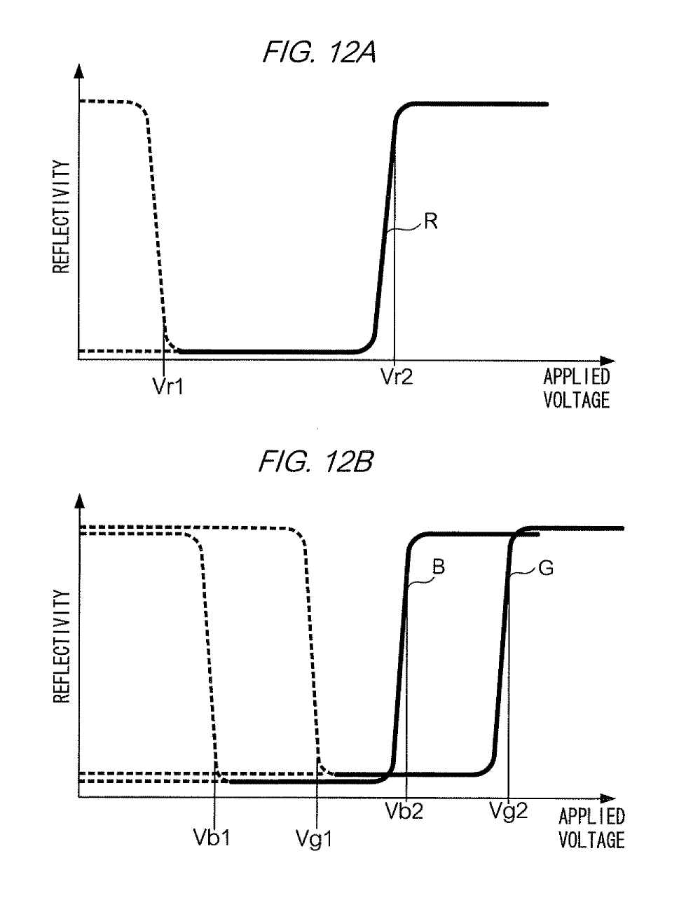

FIG. 12A shows a relationship between a voltage applied to display layer 204R via electroconductive layers and a photosensitive layer and a normalized light reflectivity of display layer 204R, and FIG. 12B shows a relationship between a voltage applied to a stack of display layers 204G, 204B and a normalized reflectivity of each display layer. Curved line R in FIG. 12A represents a relationship between an applied voltage and a normalized light reflectivity of display layer 204R, curved line G in FIG. 12B represents a relationship between an applied voltage and a normalized light reflectivity of display layer 204G, and curved line B in FIG. 12B represents a relationship between an applied voltage and a normalized light reflectivity of display layer 204B.

Provided that Vb1 represents a threshold voltage for a transition of cholesteric liquid crystal of display layer 204B from the planar state to the focal-conic state and Vb2 represents a threshold voltage for a transition of the same from the focal-conic state to the homeotropic state, in a case where the voltage applied to a display layer unit constituted of a stack of display layer 204B and display layer 204G via the electroconductive layers and the photosensitive layer is equal to or larger than Vb2 before termination of the voltage application, the cholesteric liquid crystal of display layer 204B will be in the planar state after the voltage application is terminated, to reflect green light contained in external light. On the other hand, in a case where the voltage applied to display layer unit via the electroconductive layers and the photosensitive layer is between Vb1 and Vb2 before termination of the voltage application, the cholesteric liquid crystal of display layer 204B will be in the focal-conic state after the voltage application is terminated, to allow external light to pass therethrough.

Compared with the exemplary embodiment, in the configuration shown in FIG. 11, display layer 204B is disposed between electroconductive layer 202A and 202B instead of display layer 204R. Thus, it will be understood that the alignment state of a portion of the cholesteric liquid crystal of each display layer 204G, 204B can be changed locally from the focal-conic state to the planar state. With regard to display layer 204R, by controlling voltage-applying unit 103 and light output unit 102 in the manner described in the foregoing for the single display layer structure, it is possible to locally change the alignment state of a portion of the cholesteric liquid crystal of display layer 204R from the focal-conic state to the planar state. Thus, in this modified embodiment, the display medium can reflect three colors of light, and by controlling the combination of reflected colors of light, it is possible to display an image with eight colors including red, blue, green, yellow, cyan, magenta, white, and black.

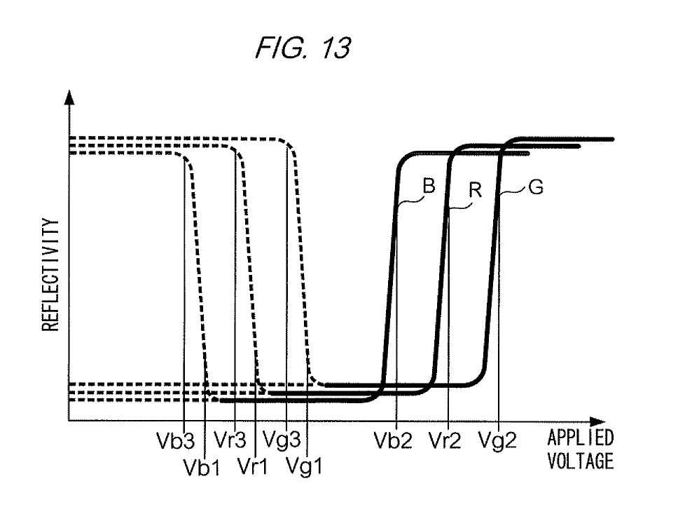

In the foregoing exemplary embodiment, two display layers are disposed between electroconductive layers 202A and 202B to constitute a display layer unit. However, it is possible that display layers 204R, 204G, 204B are disposed between electroconductive layers 202A and 202B to form a display layer unit. In such a case, a voltage applied to the stack of display layers (or the display layer unit) and a normalized light reflectivity of each display layer may have a relationship as shown in FIG. 13. To change the alignment state of a portion of the cholesteric liquid crystal of the display layers, writing device 1 may apply a bias voltage to the electroconductive layers such that a divisional effective voltage applied to the display layer unit becomes equal to a value between Vg1 and Vb2 in a condition that no light is irradiated, and may control light output unit 102 to control the effective voltage applied to portions of the display layer unit, to thereby control the position(s) where the alignment state transition to the homeotropic state (and eventually to the planar state) takes place. In this modified embodiment also, the time period of voltage application performed by voltage-applying unit 103 for locally changing the alignment state of a portion of the cholesteric liquid crystal to the planar state is set shorter than the first time period and longer than the second time period.

In this modified embodiment, display layer 204B having the smallest lower threshold voltage corresponds to the first display layer, display layer 204R having the second smallest lower threshold voltage corresponds to the second display layer, and display layer 204G having the largest lower threshold voltage corresponds to the third display layer. Also, in the present specification, the lower threshold voltage of the third display layer is referred to as a fifth threshold voltage, and an upper threshold voltage of the third display layer is referred to as a sixth threshold voltage.

In writing device 1, means for irradiating light onto the light-irradiated side of display medium 21 is not limited to a liquid crystal display. It is possible to arrange light emitting diodes in a plane, and selectively turn on the light emitting diodes in accordance with a position signal to thereby irradiate light onto a desired portion(s) on the light-irradiated side of display medium 21. Further, instead of the liquid crystal display, an EL (electroluminescent) display or any other display device using a material that emits light in response to a voltage application may be utilized. Also, the liquid crystal display may be any of a variety of types. For example, the liquid crystal display may be a monochromatic type having a backlight unit that can selectively emit one of three colors of light (red light, green light, blue light) and that is capable of setting a state of each pixel to either of a light-transmitting state or a light non-transmitting state. Furthermore, another plane-type display device, such as a CRT (Cathode Ray Tube), PDP (Plasma Display Panel), FED (Field Emission Display), SED (Surface-conduction Electron-emitter Display), may be used to irradiate light onto display medium 21.

The foregoing description of the embodiments of the present invention is provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A writing device for writing an image to a display medium, the display medium containing (a) a display layer unit that includes a first display layer, the first display layer having a liquid crystal that undergoes transition to a light-transmissive state when a voltage equal to or larger than a first threshold voltage and smaller than a second threshold voltage is applied to the display layer unit at least for a predetermined first time period, and that undergoes transition to a light-reflecting state when a voltage equal to or larger than the second threshold voltage is applied to the display layer unit at least for a predetermined second time period that is shorter than the first time period, after which the voltage is decreased to a predetermined voltage smaller than the first threshold voltage, (b) a pair of electroconductive layers between which a voltage is applied, the pair of electroconductive layers sandwiching the display layer unit therebetween, and (e) a photosensitive layer interposed between the pair of electroconductive layers, wherein when light is irradiated onto a portion of the photosensitive layer, an electric resistance of the light-irradiated portion of the photosensitive layer decreases in accordance with an intensity of the light, the writing device comprising:
a voltage-applying unit that applies a voltage between the pair of electroconductive layers; and
a light-irradiating unit that irradiates light onto the photosensitive layer,
wherein the light-irradiating unit irradiates light onto a region of the photosensitive layer that overlaps a region of the display layer unit where the liquid crystal of the first display layer is to undergo transition to the light-reflecting state, and the voltage-applying unit applies a voltage between the pair of electroconductive layers for a time period equal to or longer than the second time period and shorter than the first time period, such that a voltage equal to or larger than the second threshold voltage is applied to the region of the display layer unit where the liquid crystal of the first display layer is to undergo transition to the light-reflecting state, and a voltage smaller than the second threshold voltage is applied to a region of the display layer unit overlapped by a region of the photosensitive layer to which no light is irradiated.

2. The writing device according to claim 1, the display layer unit further including a second display layer, the second display layer having a liquid crystal that undergoes transition to a light-transmissive state when a voltage equal to or larger than a third threshold voltage, which is larger than the first threshold voltage and smaller than the second threshold voltage, and smaller than a fourth threshold voltage, which is larger than the second threshold voltage, is applied to the display layer unit at least for the first time period, and that undergoes transition to a light-reflecting state when a voltage equal to or larger than the fourth threshold voltage is applied to the display layer unit at least for the second time period, after which the voltage is decreased to a predetermined voltage smaller than the third threshold voltage,
wherein the light-irradiating unit irradiates light of a first luminous intensity onto a region of the photosensitive layer that overlaps a first region of the display layer unit where the liquid crystal of the first display layer is to undergo transition to the light-reflecting state and the liquid crystal of the second display layer is to remain in a current state, and irradiates light of a second luminous intensity onto a region of the photosensitive layer that overlaps a second region of the display layer unit where the liquid crystal of each of the first display layer and the second display layer is to undergo transition to the light-reflecting state, and the voltage-applying unit applies a voltage between the pair of electroconductive layers for a time period equal to or longer than the second time period and shorter than the first time period, the voltage applied between the pair of electroconductive layers and the first and second luminous intensities being selected such that a voltage equal to or larger than the second threshold voltage and smaller than the fourth threshold voltage is applied to the first region of the display layer unit, a voltage equal to or larger than the fourth threshold voltage is applied to the second region of the display layer unit, and a voltage smaller than the second threshold voltage is applied to a region of the display layer unit overlapped by a region of the photosensitive layer to which no light is irradiated.

3. The writing device according to claim 1, the display layer unit further including a second display layer and a third display layer, the second display layer having a liquid crystal that undergoes transition to a light-transmissive state when a voltage equal to or larger than a third threshold voltage, which is larger than the first threshold voltage and smaller than the second threshold voltage, and smaller than a fourth threshold voltage, which is larger than the second threshold voltage, is applied to the display layer unit at least for the first time period, and undergoes transition to a light-reflecting state when a voltage equal to or larger than the fourth threshold voltage is applied to the display layer unit at least for the second time period, after which the voltage is decreased to a predetermined voltage smaller than the third threshold voltage, the third display layer having a liquid crystal that undergoes transition to a light-transmissive state when a voltage equal to or larger than a fifth threshold voltage, which is larger than the third threshold voltage and smaller than the second threshold voltage, and smaller than a sixth threshold voltage, which is larger than the fourth threshold voltage, is applied to the display layer unit at least for the first time period, and undergoes transition to a light-reflecting state when a voltage equal to or larger than the sixth threshold voltage is applied to the display layer unit at least for the second time period, after which the voltage is decreased to a predetermined voltage smaller than the fifth threshold voltage,
wherein the light-irradiating unit irradiates light of a first luminous intensity onto a region of the photosensitive layer that overlaps a first region of the display layer unit where the liquid crystal of the first display layer is to undergo transition to a light-reflecting state and the liquid crystal of the second display layer and the third display layer is to remain in a current state, irradiates light of a second luminous intensity onto a region of the photosensitive layer that overlaps a second region of the display layer unit where the liquid crystal of each of the first display layer and the second display layer is to undergo transition to the light-reflecting state and the liquid crystal of the third display layer is to remain in a current state, and irradiates light of a third luminous intensity onto a region of the photosensitive layer that overlaps a third region of the display layer unit where the liquid crystal of each of the first display layer, the second display layer, and the third display layer is to undergo transition to the light-reflecting state, and the voltage-applying unit applies a voltage between the pair of electroconductive layers for a time period equal to or longer than the second time period and shorter than the first time period, the voltage applied between the pair of electroconductive layers and the first, second, and third luminous intensities being selected such that a voltage equal to or larger than the second threshold voltage and smaller than the fourth threshold voltage is applied to the first region of the display layer unit, a voltage equal to or larger than the fourth threshold voltage and smaller than the sixth threshold voltage is applied to the second region of the display layer unit, a voltage equal to or larger than the sixth threshold voltage is applied to the third region of the display layer unit, and a voltage smaller than the second threshold voltage is applied to a region of the display layer unit overlapped by a region of the photosensitive layer to which no light is irradiated.

4. The writing device according to claim 1, wherein the light-irradiating unit irradiates light onto a region of the photosensitive layer that overlaps a region of the display layer unit where the liquid crystal of the first display layer is to undergo transition to the light-transmissive state, and the voltage-applying unit applies a voltage between the pair of electroconductive layers for a time period equal to or longer than the first time period, such that a voltage equal to or larger than the first threshold voltage and smaller than the second threshold voltage is applied to the region of the display layer unit where the liquid crystal of the first display layer is to undergo transition to the light-transmissive state, and a voltage smaller than the first threshold voltage is applied to a region of the display layer unit overlapped by a region of the photosensitive layer to which no light is irradiated.

5. The writing device according to claim 2, wherein the light-irradiating unit irradiates light of a third luminous intensity onto a region of the photosensitive layer that overlaps a third region of the display layer unit where the liquid crystal of the first display layer is to undergo transition to the light-transmissive state and the liquid crystal of the second display layer is to remain in a current state, and irradiates light of a fourth luminous intensity onto a region of the photosensitive layer that overlaps a fourth region of the display layer unit where the liquid crystal of each of the first display layer and the second display layer is to undergo transition to the light-transmissive state, and the voltage-applying unit applies a voltage between the pair of electroconductive layers for a time period equal to or longer than the first time period, the voltage applied to the pair of electroconductive layers and the third and fourth luminous intensities being selected such that a voltage equal to or larger than the first threshold voltage and smaller than the third threshold voltage is applied to the third region of the display layer unit, a voltage equal to or larger than the third threshold voltage and smaller than the second threshold voltage is applied to the fourth region of the display layer unit, and a voltage smaller than the first threshold voltage is applied to a region of the display layer unit overlapped by a region of the photosensitive layer to which no light is irradiated.

6. The writing device according to claim 3, wherein the light-irradiating unit irradiates light of a fourth luminous intensity onto a region of the photosensitive layer that overlaps a fourth region of the display layer unit where the liquid crystal of the first display layer is to undergo transition to the light-transmissive state and the liquid crystal of each of the second display layer and the third display layer is to remain in a current state, irradiates light of a fifth luminous intensity onto a region of the photosensitive layer that overlaps a fifth region of the display layer unit where the liquid crystal of each of the first display layer and the second display layer is to undergo transition to the light-transmissive state and the liquid crystal of the third display layer is to remain in a current state, and irradiates light of a sixth luminous intensity onto a region of the photosensitive layer that overlaps a sixth region of the display layer unit where the liquid crystal of each of the first display layer, the second display layer, and the third display layer is to undergo transition to the light-transmissive state, and the voltage-applying unit applies a voltage between the pair of electroconductive layers for a time period equal to or longer than the first time period, the voltage applied to the pair of electroconductive layers and the fourth, fifth and sixth luminous intensities being selected such that a voltage equal to or larger than the first threshold voltage and smaller than the third threshold voltage is applied to the fourth region of the display layer unit, a voltage equal to or larger than the third threshold voltage and smaller than the fifth threshold voltage is applied to the fifth region of the display layer unit, a voltage equal to or larger than the fifth threshold voltage and smaller than the second threshold voltage is applied to the sixth region of the display layer unit, and a voltage smaller than the first threshold voltage is applied to a region of the display layer unit overlapped by a region of the photosensitive layer to which no light is irradiated.
